(19) United States
(12) Patent Application Publication
(10) Pub. No.: US 2009/0199006 A1
(43) Pub. Date: Aug. 6, 2009

(54) Method and Device for Secure Mobile Electronic Signature

(76) Inventor: Maik Stohn, Kriftel (DE)

Correspondence Address: Nixon Peabody LLP, 200 Page Mill Road, Suite 200, Palo Alto, CA, 94306, US

(21) Appl. No.: 12/363,761

(22) Filed: Jan. 31, 2009

(30) Foreign Application Priority Data
Feb. 1, 2008 (DE) 10 2008 007 367.9

(51) Int. Cl. H04L 9/00

(52) U.S. Cl. 713/173

(57) ABSTRACT

The present invention relates to a mobile, portable and compact signature device which is used for simple and secure signature of information by a user. In particular the device is protected from manipulation attempts by the combination of two measures: firstly the architecture ensures that information can only be shown on the display and signed when decrypted by the Smartcard in the device and thus intended for a specific user identity represented by the Smartcard. Secondly further manipulation opportunities for a potential attacker are restricted by the permanent combination in everyday use of the signature device with display and Smartcard. The area of application of the signature device disclosed and associated method includes but is not restricted to the authorisation of financial transactions.

This application claims priority of and incorporates by reference DE 10 2008 007 367.9 filed Feb. 1, 2008. The invention relates to a mobile personal device for secure electronic signature and a corresponding method.

### AREA OF THE INVENTION

In communication and in particular business communication, it is often essential to verify the authenticity of information transmitted and the identity of the business partner. This can be achieved using electronic signatures. The process of electronic signature normally comprises three part steps: transmission of the information to be signed, preferably electronically; display of the information to be signed; and generation of the actual electronic signature. It must be ensured that the electronic signature relates precisely to the information or document to be signed.

Due to the public character of the channels used preferably for information transfer, it cannot be excluded that data transmitted can be viewed or even manipulated by third parties. This is generally resolved by encryption [1] of sensitive data in public networks. However this only offers security for the part of information transmission.

There are further points of attack in addition to information transmission. The systems used to display and receive information, such as for example computer systems or terminals, must generally be considered as open to manipulation. This is illustrated by the existence of security gaps in operating systems, viruses, Trojans and phishing attacks. Even if the information transmitted is protected from manipulation on transfer by encryption, it must be displayed to the user unencrypted at a particular time, and edited or confirmed. There are therefore opportunities for manipulating the process if the device for display or reception of information (e.g. a computer) is manipulated by third parties. In this case despite encryption of the data transmitted, it can occur that the information displayed by the manipulated systems is not identical to the information actually signed. This can occur for example due to Trojan programs which give the user the impression that he is communicating with a business partner (for example the bank) whereas in fact he is communicating with or via a Trojan program, whereby the Trojan can obtain corresponding information such as passwords and TAN numbers.

The present invention relates to a device and a method for secure digital signature. A novel architecture guarantees that the information displayed actually corresponds to the information signed. Thus manipulation attempts are substantially more difficult than in the prior art.

### PRIOR ART

Although there are a multiplicity of uses of electronic signatures, the prior art will be explained using the example of electronic payment of goods or services. The present invention also covers but is not restricted to this area of application.

In electronic payment, the user must identify himself to the credit institute or service provider. The amount to be paid is then displayed and optionally further information shown. The user authorises the procedure by entering his PIN number and where applicable an optional transaction number (TAN). In more recent architectures, the user may have an electronic Smartcard that contains an electronic key which can encrypt and thus sign electronic messages. Often such methods are based on a public key infrastructure (PKI) [2].

The object achieved by the present invention is described below, in that a manipulation theoretically possible in the current state of the art is explained.

Chipcard readers are currently allocated to four security classes as specified in Germany by the Central Credit Committee (ZKA [3]) [4]:

| | |
|---|---|
| Security Class 1 | Devices of this class have no special security features. The card |
| | reader serves merely as a contact unit for the chipcard. |
| Security Class 2 | These chipcard readers have a keypad via which for example the |
| | PIN required for home banking can be entered directly. Thus |
| | spying on the PIN (for example by keyloggers or Trojans) is |
| | practically excluded. |
| Security Class 3 | In addition to the keypad, these units have a display and an |
| | inbuilt “intelligence” with which for example it is also possible to |
| | pay on the internet using the money card. |
| Security Class 4 | As class 3, but the terminal has its own identity which cannot be |
| | manipulated. This is guaranteed by a second Smartcard inserted |
| | in the terminal. |

Further explanations on device classes for chipcard readers are given in [5, 6]. This shows that for security class 3, the keypad and display are, at least for part of the time, controlled exclusively by the firmware of the chipcard terminal and there is no possibility of logging keypad inputs from the connected computer system. The chipcard reader does not pass on requests directly to the chipcard but first checks them. It is here that there is a weakness: all chip card readers based on this standard can be controlled with a corresponding, standard key for the firmware. If this is known, all readers of this class must be regarded as insecure.

FIG. 1 shows diagrammatically a Smartcard customer terminal of security class 3 to illustrate the prior art. The user 1 can read information from the display 7 and make inputs via the input unit 5 which can contain a keyboard and/or touch-sensitive screen. The Smartcard 9 is controlled by the firmware 11. The firmware only allows access to the Smartcard 9 when this can be checked with a key generic for this terminal class. The communication interface 13 constitutes an interface to the communication partner (e.g. the bank). The Smartcard 9 is inserted into various terminals 3 for various signature processes. If an attacker succeeds in manipulating the firmware 11 via the communication interface 13 or through the device by physical modification, the user 1 may be shown content different to that which he is actually signing. As also there are multiplicity of terminals of the same construction with identical firmware and identical check algorithms, if an attacker has knowledge of the key for the firmware, all terminals of this type must be regarded as compromised.

Many Smartcard readers also offer a facility for updating the firmware or downloading keys for transaction checking. This mechanism itself also offers the opportunity for manipulation.

In addition the card reader in many cases remains at the point of payment and could therefore be manipulated without the knowledge of the user. Even if the card reader is sealed in its original state, manipulation can be very difficult for the user to detect.

Manipulation of the firmware and/or hardware of the reader could therefore achieve that the information shown on the display is not the information signed by the user.

The literature describes many different approaches to resolve this problem, but all have specific drawbacks. Smartcard terminals of security class 4 generally have a further Smartcard which represents the identity of the terminal concerned [5]. In this case the administrative cost is high as this identity must be administered and registered, in addition to that of the user. Furthermore such a terminal remains with the trader and could therefore be manipulated without the knowledge of the user.

The patent application [7] admittedly describes the inseparable combination of a Smartcard with a display, but is mainly concerned with the integration of a display in a flexible card and does not relate to details for increasing the security of the signature process. Patent application [8] for a secure signature does not disclose how manipulation of the signature device display can be avoided. Patent application [9] describes the combination of a display with a Smartcard, where the entire unit is in chip card format. A switch fitted is not however used for signature but for display of stored information, such as for example a credit balance. In a further patent application [10] a chip card is described with integral display and keypad, which can be used for payment transactions. However no details of the information architecture are disclosed, with which the card is protected from manipulation by third parties. In the press release [11] from the Fraunhofer company, an architecture is presented which solves the problem of manipulation of the PC used and its peripherals. This arrangement, in contrast to the present invention, is not however suitable for mobile use. Patent application [12] describes a portable system for signature of information. The main content is however the encoding of information in acoustic signals and implementation within a mobile radio system. Document [13] also discloses an arrangement and a method for mobile signature. This system however works with a mobile telephone, using telephone networks, which constitutes a restriction. A modern mobile telephone is a system which can be manipulated by software; already viruses and malicious programs exist for mobile telephones. In this sense, such a device is not reliable and should be classed as a PC. The solution of the main task of the present invention, the guarantee of conformity of the message displayed and signed, was not disclosed in [13].

### DESCRIPTION OF THE INVENTION

The object of the present invention is to ensure conformity of the message signed with that displayed.

The present invention relates to a device and a method for secure signature, implemented by a device for authorisation of information or release of transactions, referred to below as the signature device. The signature device contains a Smartcard or slot for this and is equipped with at least one display. The Smartcard can also be integrated in the signature device as a fixed and inseparable function module.

The object of the invention is to exclude a difference between the information shown (e.g. transaction information) and the information actually signed on a signature device. This is achieved according to the invention by a combination of two measures:

Firstly the hardware is constructed such that the device display only shows content which is signed for the respective and individually varying user identity. This is achieved in that the signing device displays only that information which is intended for the Smartcard inserted therein and hence the specific user. This can be guaranteed in that the communication partner of the signature device (e.g. credit institute) sends information which can only be decrypted by the Smartcard of the current user and is shown on the display under the direct control or with the collaboration of the Smartcard. It is a characteristic feature of the arrangement that the signing device only displays information received from outside when this has been authorised by the user-specific Smartcard.

This first measure alone however is not sufficient, as manipulation of the hardware of the signature device and hence the information displayed and signed would still be possible. Therefore according to the invention it is combined with a second measure: The combination between Smartcard and display which shows transaction information, is not normally separated and is under the control of the user. The user has no interest in manipulating his own transactions. The interface between Smartcard and display is very difficult for third parties to manipulate, since in general it is not accessible to the trader or vendor of the service or other third parties. According to the invention, the Smartcard and display form one unit which is under the control of the user and can be used at various locations. Although the Smartcard for example is inserted in the signature device on first use, it normally remains paired with the signature device for further successive signature procedures.

If despite this a third party succeeds in manipulating the interface between the Smartcard and display and also comes into possession of the PIN number, an abuse can take place only with a single user identity (a single Smartcard). In contrast, in the prior art with a stationary reader in the trader's premises, by manipulation of a single hardware (display and PIN input keypad), transactions of various user identities can be manipulated.

According to the present invention, signature actions can be performed and in particular transaction information displayed only if the communication partner (e.g. the credit institute) has the key valid for the specific Smartcard.

The signature device according to the invention contains at least one display and one Smartcard. Also there may be an input facility for a PIN number on the signature device. This can take the form of a keypad or a touch-sensitive screen or a fingerprint reader. The PIN number is verified using the Smartcard. The PIN number can also be input via hardware components of a connected host system (e.g. a PC). This system must generally be regarded as insecure and an attack on the PIN by Trojan programs is theoretically possible. Such an attack would however be unsuccessful, since to perform a signature action the physical Smartcard is also required at the same time.

### DESCRIPTION OF FIGURES

The figures are described briefly below and do not intended to limit the scope of protection. Here:

FIG. 1 shows the diagrammatic structure of a Smartcard customer terminal of security class 3 to illustrate the prior art;

FIG. 2 shows the structure of a signature device according to the invention;

FIG. 3a, 3b show a top view and FIG. 3b a side view of an arrangement to implement the present device;

FIGS. 4a, 4b show further embodiment examples.

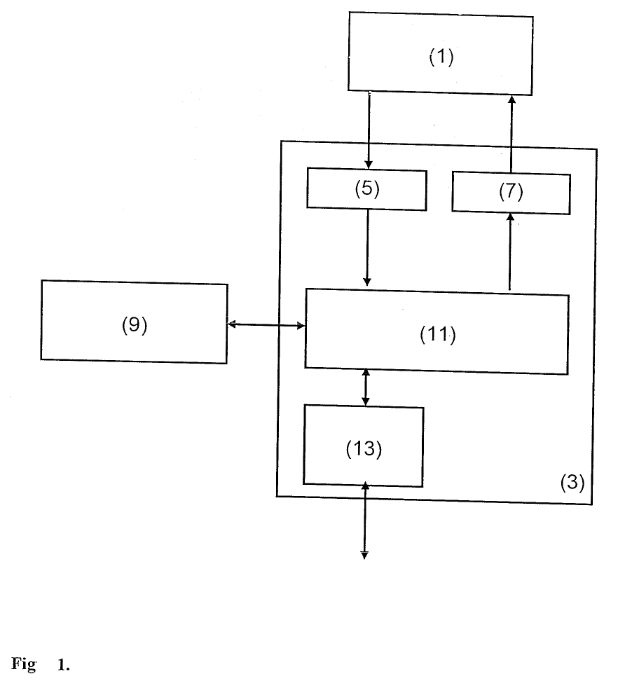

### DESCRIPTION OF EMBODIMENTS

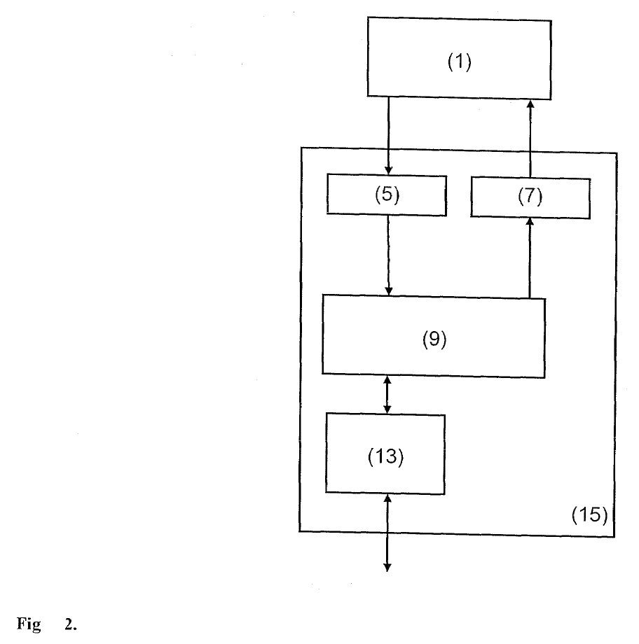

The structure of a signature device according to the invention is illustrated in FIG. 2. The Smartcard 9 is directly connected with the communication port 13 and normally remains in the signature device 15. The architecture is designed such that information is shown on the display 7 only when it has been authorised by the Smartcard 9 by means of a key specific to the user concerned. Direct manipulation of the display 7 or input unit 5 without authorisation via the Smartcard is excluded.

A further feature of the arrangement according to the invention is a signature mechanism which is particularly secure and also simple to operate. On the signature device is a button as part of the input unit 5, wherein the hardware can be controlled exclusively by the user of the signature device and in no case externally. At the same time this button is designed such that is cannot be activated accidentally. Preferably the button always has the same functions for signature or release. When it is activated, it triggers the signature or confirmation of the information currently shown on the display by the user using his Smartcard. It is characteristic that the signature operation is preferably triggered with a single activation. In alternative embodiments, several buttons or combinations thereof can be pressed. A reader of class 2 for example has a secure input facility for a PIN, wherein the technical design is such that a manipulation or capture of keypad inputs is excluded or rendered very difficult by the hardware construction. This arrangement according to the prior art however constitutes a disadvantage since it is very difficult to build a keypad for input of a PIN and confirmation to be small and transportable. According to the invention, the presence of a single, secured, non-manipulatable hardware element, for example such as a button, for release or signature is sufficient. The PIN can be entered on other input devices which may have to be regarded as insecure. If a Trojan program succeeds in gaining possession of the PIN, this is not sufficient. Even on knowledge and input of the PIN by a Trojan program, no abuse can occur since the button for signature of the message displayed cannot be activated or manipulated by software without physical access to the device. The absence of a complete keypad for PIN input does not therefore constitute an increased security risk, as a single hardware element which cannot be manipulated physically, the button for signature release, is sufficient. This knowledge according to the invention allows the construction of very small, portable but nonetheless secure signature devices. Because of miniaturisation it is reasonable for the user to carry the signature device with him, and manipulation of the hardware is rendered more difficult because the signature device is carried.

Furthermore a signature process can be very simply and quickly interrupted. If the signature device does not exchange information wirelessly, the signature process can easily be interrupted by termination of the physical connection (for example separation from the USB port). On wireless coupling, which is preferably implemented by short-range wireless connection, the signature process can be interrupted accordingly by removal of the terminal provided.

The arrangements and associated method according to the invention are explained below with reference to examples. One possible embodiment of the invention is a portable signature device described here for authorising payment processes or other transactions. The present invention is not however restricted to this application.

FIG. 3a shows a top view and FIG. 3b a side view of an arrangement for implementing the present invention. The signature device 15 has a display 17 and a communication port 21. In this embodiment example the communication port is designed as a USB interface. However wireless connections (IRDA, WLAN, Bluetooth, USB wireless) or combinations of wired and wireless connections are possible. The communication port 21 can optionally be protected by a cover, not shown in FIG. 3. The Smartcard 23 is visible in the side view in FIG. 3b. This can be a slot for a Smartcard, a Smartcard installed inside the signature device 15 on first use, or a Smartcard permanently housed in the signature device. It is important that the Smartcard remains in the signature device 15 in everyday use to restrict potential for manipulation.

The control element 19 of the signature device serves as a simple trigger of the signature process, wherein pressing the control element, preferably designed as a button, signs the information currently shown in the display with the user identity contained on the Smartcard. It is important that the hardware of control element 19 cannot be manipulated externally by software but a physical activation is required. To achieve this, the working memory of the device in one possible embodiment is write-protected or can be connected in a write-protected mode. For the signature process a public key infrastructure [2] can be used according to the prior art.

FIG. 3a indicates a housing form in the vicinity of the control element which, as an advantageous embodiment of the present invention, makes accidental activation of the control element unlikely. In this embodiment example there are no visible input facilities for a PIN number. This can be input via separate keys which can be read via the communication port 21. Alternatively the display 17 can be designed as a touch-sensitive screen which can be used for input of a PIN number or for identification of a fingerprint.

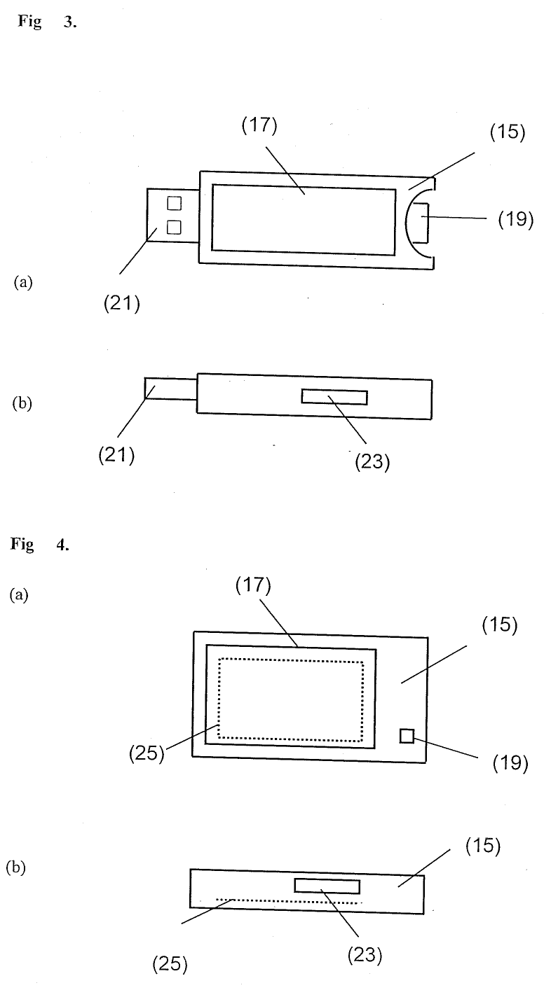

A further embodiment example is shown in FIG. 4. FIG. 4a shows a top view and FIG. 4b a side view of an arrangement for implementing the present invention. The signature device 15 has a display 17 which is preferably implemented as a touch-sensitive screen and can also be used for input of PIN numbers. The control element 19 triggers the signature of the information shown on the display. The device can be coupled to the outer world via an inductive loop or an antenna 25. This allows the exchange of data and/or the provision of energy. According to the invention, the signature operation can be initiated by laying the signature device 15 on a point provided for this and preferably marked. This is achieved by coupling with a second inductive loop (not shown in FIG. 4) which supplies the device with energy and/or data. The user can interrupt an undesirable signature operation at any time by removal of the device or decoupling of the inductive loop by removal of the signature device. The function of the control element 19 can also be implemented on the display 17 in the case of a touch-sensitive version. As in the previous example, a PIN number can also be entered via an input device with which the signature device communicates via a communication interface. Also a fingerprint sensor can be used which also detects identity. The Smartcard 23 is shown in side view in 4b. This can be a slot for a Smartcard, a Smartcard installed inside the signature device 15 on first use, or a Smartcard firmly integrated in the signature device. In this embodiment example too, the architecture of the signature device 15 is structured such that the display 17 shows only information which has been authorised or decrypted by the Smartcard 23.

The method is preferably based on the above device. Here in a first step the mobile signature device according to the invention is connected with a PC or recording till via an interface (e.g. USB). The latter are in turn connected with a server which normally receives or executes the card or online banking transactions. The device according to the invention is now connected for example with the computer via the USB port. In addition drivers or program information can be stored on a memory zone (which can be formed as a USB hard disk and started by auto start) so that the mobile personal signature device can now receive information from or exchange information with the PC and/or server. The auto start request allows the drivers or required program information to be started automatically on connection. In the case of a recording till, the till immediately recognises from the connected device that signature must take place via the device according to the invention, and diverts the corresponding communication with the server if the device according to the invention cannot communicate directly with the server. In the PC-oriented online banking variant, an application communicating with an internet browser recognises the presence of a mobile signature device. This now either controls the release of the transaction automatically via the signature device without input of a TAN, or in a dialogue a selection is prepared so that the user can decide in which form he wishes to release the transaction. This program can e.g. be a Java-Applet or similar which is loaded by retrieving the internet home banking site. The user now has a choice of working with the signature device or a TAN. If he chooses the signature device for example, the input information is transmitted to the server. The server can modify the information so that it can be decrypted by the Smartcard. This can be achieved by signature or by encryption.

The information processed and/or encrypted in this way is sent by the server to the mobile personal signature device. This can take place directly or via the PC. Thus for example the device according to the invention can receive data via NAT as a specific network device. Alternatively the PC can transfer data on the installed drivers or the program installed by auto run to the device according to the invention.

The device receives or processes the information only if the information is correctly encrypted. This avoids the device receiving or being hindered by undesirable information. If the information has been correctly modified/encrypted, it is shown on the display and the system waits for release by the user. The complete transaction information is displayed. This comprises e.g. the amount, the source account and the destination account.

After input by the user via the input unit, the information is signed by the personal mobile signature device and transmitted to the server. It must be noted that the input e.g. can take place only via a key or touch screen or fingerprint reader. The data for fingerprints can be integrated for example in the chipcard/Smartcard.

The device control system is structured such that the information shown on the display is not signed and all actions are interrupted if the device is separated from the interface, in particular the USB port.

In the preferred embodiment, a connection is implemented via a standard PC interface (USB, FireWire) or a wireless interface such as Bluetooth or WLAN. The power is supplied by an integral battery, the USB/FireWire interface or by radio e.g. RFID.

The signature process is also interrupted by separating the energy supply, where the energy supply can be implemented by direct electrical connection or inductive coupling, wherein this manner of coupling can optionally also be used to transmit data.

Furthermore the input of a PIN number for authorising the signature process need not be part of the mobile signature device but can take place on a connected or communicating device. Release however must take place on the device itself.

The description intends not to limit the scope of protection. The scope of protection is defined by the claims only.

### LITERATURE REFERENCES

[1] Steve Burnett, Stephen Paine: “RSA Security's Official Guide to Cryptography”, McGraw-Hill Professional (2002)
[2] Carlisle Adams, Steve Lloyd: “Understanding Public-Key Infrastructure: Concepts, Standards, Deployment Considerations”, Macmillan Technical Publishing (1999)
[3] Central Credit Committee http://www.zentraler-kreditausschuss.de
[4] http://de.wikipedia.org/wiki/Chipkarte (version 21.11.2007)
[5] Kobil Systems GmbH, Worms. www.kobil.de/index.php?id=135&type=2&L=1 (version 21.11.2007)
[6] Initiative Geldkarte e.V. http://www.initiativegeldkarte.de/_www/de/pub/geldkarte_initiative/initiative_geldkarte/aktuelles/hintergrundtext_chipkartenles.php (version 22.11.07)
[7] DE10210606, GIESECKE & DEVRIENT GMBH (2003): “Display module credit card/payment card/money payment having display module and chip module with conductor track conjugate contact zones and electronic control chip tracks connected/encapsulated”
[8] WO9908415, Siemens AG (1999), “SYSTEM FOR GENERATING ELECTRONIC SIGNATURES IN ABSOLUTE SECURITY”
[9] DE 10221496, GIESECKE & DEVRIENT GMBH (2004), “Data carriers”
[10] DE10008076, FREUDENBERG CARL FA (DE), (2001), “Chipcards”
[11] Fraunhofer company, Press Release 2003: “Secure signing terminal uses PC peripheral”, http://idw-online.de/pages/de/news59463 (version 23.11.2007)
[12] US2007143622, Isaac Labaton (2007), METHODS AND PORTABLE DEVICE FOR DIGITALLY SIGNING DATA
[13] DE 19747603C2 Brokat GmbH, Method for digital signing of a message.

1. Mobile personal device with secure electronic signature comprising:
at least one display for depiction of information,
an integrated Smartcard or a connecting means for a Smartcard designed so that the Smartcard is permanently held,
an input unit for interaction,
an interface which allows a removable connection at different locations,
which can thus be used for signing information at different locations, via which the information to be signed is received and via which the signed information is returned,
with a control system designed and structured such that the display shows only information which is decrypted by the Smartcard and thus intended for a specific user ID that is defined by the Smartcard, wherein a signature action in relation to the information displayed necessarily requires an input via the input unit,
a power supply which is provided via the interface or via an integral battery.

2. The device according to claim 1, wherein the interface is connected to the communication means which at the site of performance of a signature action allows direct or indirect connection of the said arrangement with a communication channel such as for example the internet, a telephone connection or a mobile telephone connection in order for the information to be signed to be received from the server.

3. The device according to claim 1, wherein a housing has a form factor which is no greater than a mobile telephone and preferably the size of a USB stick.

4. The device according to claim 1, wherein the interface can be formed as a wired standard PC interface (USB, FireWire) or as a wireless interface such as Bluetooth or WLAN.

5. The device according to claim 1, wherein the input unit serves for release of the signature of the information shown on the display, and is preferably a push button which triggers a signature operation in relation to the information on the display with just one activation.

6. The device according to claim 5, wherein the push button is protected from accidental pressing by constructional measures.

7. The device according to claim 1, wherein the input unit for triggering the signature process is implemented such that manipulation by software is excluded and to trigger the signature process the element must be physically activated.

8. The device according to claim 1, wherein the input unit for triggering the signature operation is also implemented using a touch-sensitive screen.

9. The device according to claim 1, wherein the input unit for triggering the signature operation is equipped with a fingerprint reader.

10. The device according to claim 1, wherein the control system is structured such that the information shown on the display is not signed and any action is interrupted if the device is separated from the interface, in particular the USB port.

11. The device according to claim 1, wherein any signature process is interrupted by separation of the energy supply, wherein this energy supply can be implemented by direct electrical connection or inductive coupling, wherein this type of coupling can optionally also be used for data transmission.

12. The device according to claim 11 comprising a RFID chip.

13. The device according to claim 1, comprising a data carrier area for a program, the program is started on creation of the connection with the interface so that communication with a server via the interface takes place via a network.

14. The device according to claim 13, wherein the only data received from the server are that which are decrypted by the Smartcard and thus intended for a specific user ID established by the Smartcard.

15. The device according to claim 1, wherein the interface and preferably the program are formed so as to allow communication with and via a PC and/or recording till.

16. The device according to claim 1, wherein the hardware device for input of a PIN number for authorisation of the signature process is not part of the actual mobile signature device but is located on a connected or communicating device, however release must take place on the device itself.

17. Method for secure electronic signature with a mobile personal signature device, wherein the signature device comprises:
at least one display for depiction of information,
an integrated Smartcard or a connecting means for a Smartcard designed so that the Smartcard is permanently held,
an input unit for interaction,
an interface which allows a removable connection at different locations,
which can thus be used for signing information at different locations, via which the information to be signed is received and via which the signed information is returned,
with a control system designed and structured such that the display shows only information which is decrypted by the Smartcard and thus intended for a specific user ID that is defined by the Smartcard, wherein a signature action in relation to the information displayed necessarily requires an input via the input unit, a power supply which is provided via the interface or via an integral battery,
comprising the steps:
connecting of the mobile personal signature device via the interface with a PC or recording till, which in turn is connected with a server so that the mobile personal signature device can receive information from the server,
inputting of the information to be signed on the PC or recording till,
transmitting of the information to the server which modifies the information so that it can be decrypted by the Smartcard,
transmitting of the encrypted information by the server to the mobile personal signature device,
receiving of the encrypted information via the PC or recording till if the information is correctly encrypted,
displaying of the information on the display and waiting for release by the user,
after input by the user via the input unit, signing of the information by the mobile personal signature device and transmission to the server.

18. The method according to claim 17, wherein the interface is connected to a communication means which at the site of performance of a signature action allows direct or indirect connection of the said arrangement with a communication channel such as for example the internet, a telephone connection or a mobile telephone connection in order for the information to be signed to be received from the server.

19. The method according to claim 17, wherein the interface can be formed as a wired standard PC interface (USB, FireWire) or as a wireless interface comprising Bluetooth or WLAN.

20. The method according to claim 17, wherein the input unit serves for release of the signature of the information shown on the display, and is preferably a push button which triggers a signature operation in relation to the information on the display with just one activation.

21. The method according to claim 17, wherein the input unit for triggering the signature operation is also implemented using a touch-sensitive screen.

22. The method according to claim 17, wherein the input unit for triggering the signature operation is equipped with a fingerprint reader.

23. The method according to claim 17, wherein the control system is structured such that the information shown on the display is not signed and any action is interrupted if the method is separated from the interface, in particular the USB port.

24. The method according to claim 17, wherein any signature process is interrupted by separation of the energy supply, wherein this energy supply can be implemented by direct electrical connection or inductive coupling, wherein this type of coupling can optionally also be used for data transmission.

25. The method according to claim 24 comprising a RFID chip.

26. The method according to claim 17, comprising a data carrier area for a program, the program is started on creation of the connection with the interface so that communication with a server via the interface takes places via a network.

27. The method according to claim 26, wherein the only data received from the server are that which are decrypted by the Smartcard and thus intended for a specific user ID established by the Smartcard.

28. The method according to claim 17, wherein the interface and preferably the program are formed so as to allow communication with and via a PC and/or recording till.

29. The method according to claim 18, wherein the hardware device for input of a PIN number for authorisation of the signature process is not part of the actual mobile signature device but is located on a connected or communicating device, however release must take place on the device itself.
